(19) United States
(12) Patent Application Publication
(10) Pub. No.: US 2023/0025685 A1
(43) Pub. Date: Jan. 26, 2023

(54) SEISMIC ISOLATION STRUCTURE USING ROPE FOUNDATION

(71) Applicant: Nam Young KIM, Seoul (KR)

(72) Inventor: Nam Young KIM, Seoul (KR)

(21) Appl. No.: 17/788,189

(22) PCT Filed: Dec. 21, 2020
(86) PCT No.: PCT/IB2020/062283

§ 371 Date: Jun. 22, 2022

(30) Foreign Application Priority Data
Dec. 23, 2019 (KR) 10-2019-0172771
Feb. 26, 2020 (KR) 10-2020-0023398
Apr. 9, 2020 (KR) 10-2020-0043143
Sep. 10, 2020 (KR) 10-2020-0116201
Dec. 14, 2020 (KR) 10-2020-0174375

(51) Int. Cl. E02D 27/34; E04H 9/02

(52) U.S. Cl. CPC E02D 27/34; E04H 9/021

(57) ABSTRACT

A seismic isolation structure using a rope foundation of the present invention is to separate and support an object from a ground at the same time. The seismic isolation structure may include a base positioned on the ground and provided with an accommodating space with an opened upper portion and two or more rope supporters spaced apart around an entrance of the accommodating space, a support including a stage for supporting an object, and a column protruding downward from the stage and positioned in the accommodation space, and ropes connecting the rope supporter and the lower part of the column to support the support to be spaced apart from the base.

### TECHNICAL FIELD

The present invention relates to a seismic isolation structure capable of protecting an object from earthquake, shocks, and the like from the bedrock, the ground, and the floor.

### BACKGROUND ART

In recent years, the earthquake occurs frequently and as the damage increases, the need for earthquake resistance or seismic isolation in buildings is increasing.

In general, a ‘seismic isolation apparatus’ is a structure that blocks or reduces shocks such as earthquakes from being transmitted to the buildings from the ground, which may be referred to as an earthquake avoidance or bedrock isolation structure that avoids earthquakes. Since the buildings are built on the bedrock, the earthquakes propagating through the bedrock cannot be completely blocked, but the seismic isolation structure may mitigate the shocks of the earthquake to some extent.

In the related art, there are seismic isolation devices such as laminated rubber bearings and pendulum, but most of the devices have earthquake resistant or seismic isolating performance for buildings at a certain level, and a more effective and economical seismic isolation structure has not yet been proposed to increase the seismic isolation effect. For example, when the load of the building is large, the number of seismic isolation devices such as laminated rubber bearings and pendulum should be installed as many as they can handle the load, and the installation cost thereof may act as a heavy burden.

A ‘seismic isolation device’ of Korean Patent Registration No. 10-0850434 uses rollers and a plurality of springs to provide cushioning and restoration performance against the shock of an earthquake, and an ‘automatic restoring type bedrock isolation seismic isolator’ of Korean Patent Registration No. 10-1710612 uses shape memory steel rods for restoration.

For example, when constructing tall and large buildings, in the case where the large load and durability of the buildings need to be ensured from earthquakes for hundreds of years, the existing seismic isolation method has limitations.

### DISCLOSURE

### Technical Problem

An object of the present invention is to provide a seismic isolation structure with improved buffering and restoration performance, durability, economic feasibility, and the like against the impacts of earthquakes.

An object of the present invention is to provide a seismic isolation structure capable of separating an object to be protected from the bedrock or foundation so as to float in the air by applying a rope using a wire rope, carbon fiber, graphene, or the like.

### Technical Solution

According to an exemplary embodiment of the present invention, a seismic isolation structure using a rope foundation is to separate and support on object from a ground at the same time. The seismic isolation structure may include a base positioned on the ground and provided with an accommodating space with an opened upper portion and two or more rope supporters spaced apart around an entrance of the accommodating space, a support including a stage for supporting an object, and a column protruding downward from the stage and positioned in the accommodation space, and ropes connecting the rope supporter and the lower part of the column to support the support to be spaced apart from the base.

In the present specification, the ground may mean exposed from an exterior such as the bedrock, the ground, the building floor, and the like by vibration, shock, shaking, etc. The object is an object that is protected from vibration, shock, shaking, and the like transmitted from the ground, and may be defined in various ways without being limited by size or position, such as buildings, bridges, cultural assets, expensive equipment, and works of art.

In the present specification, the base is positioned at the lower portion, and the support receives gravity from the upper portion and receives a force in a vertical direction, but may use magnetic force or repulsive force other than the gravity, and in some cases, the base and the support may be switched up and down.

Preferably, all of the ropes connecting the upper portion of the base and the lower portion of the support may be vertically parallel with each other in a no-shaking state, and the vertical may be understood as a direction parallel to a direction in which the support is pulled or pushed with respect to the base.

According to another embodiment, two of the ropes randomly selected may form two opposite sides of a rectangle.

The support may include a flange provided at the lower portion of the column and formed with a relatively wider dimension than the column, and an angle of the rope connected from the upper part of the base, that is, the entrance of the accommodation space to the flange, may be variously adjusted by adjusting a dimension of the flange. As described above, in order to form the rope to be vertically parallel, it is also possible to design a boundary of the entrance of the accommodation space and a boundary of the flange to be in a position that is matched up and down.

In addition, it is preferable that the support and the base do not collide with each other even if the base is shaken, and to this end, collision between the support and the base may be limited by adjusting the height so that the column with the smallest dimension in the support is positioned at the entrance of the accommodation space.

The support or the base may be formed using at least one of reinforced concrete, steel frame concrete, steel frame with increased durability, a special high-strength alloy, graphene synthetic plastic containing a special alloy, graphene synthetic plastic, carbon fiber, carbon nanotube, and grapheme.

The rope may be formed using at least one of a hanger rope, a steel wire, graphene synthetic plastic containing a special alloy, graphene synthetic plastic, carbon fiber, carbon nanotube, and graphene.

The seismic isolation structure may be formed in a rectangular or circular shape in a plane.

The base may have rope guide grooves or protrusions formed around the inlet of the accommodation space to prevent the rope from moving unintentionally.

Even when excessive movement between the base and the support occurs, the front, rear, left, and right sides of the base may be opened to prevent mutual collision.

The support may further have a structure such as the above-described flange, and in order to prevent collision between the flange and the vertical column of the base, a corner of the flange may be concavely formed to further limit the collision between the support and the vertical column of the base.

A spring may be interposed in the center of the rope connecting the base and the support, and may apply elasticity to the rope within a safe range.

The seismic isolation structure may further include a spring plate provided on the upper surface of the support or the lower surface of the base to mitigate the transmission of vibration, shock, and shaking.

The seismic isolation structure may further include at least one critical shock blocking device connecting spaced spaces between the support and the base, wherein the critical shock blocking device may be installed in plural at required elements, and may be provided by the same or different device or structure according to a position.

The critical shock blocking device may provide elasticity within a predetermined interval or function as a damper. The critical shock blocking device may include anchors at both ends and a connecter connecting the anchors, and the connector may be designed to be broken when a predetermined critical shock is exceeded. The anchor and the connecter may also be connected to each other by a biner for the convenience of replacement.

Sand or gravel may be provided below the accommodation space, and a resistor buried in the sand or gravel may be formed to protrude from the lower portion of the support. When the sand or gravel is provided, the sand or gravel may additionally restrict the movement of the support.

The ropes may be provided in various methods. As an example, the ropes may be provided independently to connect the rope supporter and the lower portion of the column separately, but the ropes may be connected together to form an interconnected structure while passing through the rope supporter and the lower portion of the column or the flange. Of course, all of the ropes may not be connected as one, but may be partially connected to be formed in a connected state.

Outer rope hangers may be provided on both sides of the rope supporter, the rope may pass through to connect the outer rope hangers, and the end thereof may be connected between the outer rope hangers by a turnbuckle. In this case, it is possible to correct the length of the rope to some extent using the turnbuckle.

According to an exemplary embodiment of the present invention, a seismic isolation structure using a rope foundation may include a base positioned on the ground and providing an accommodation space with an opened upper portion, a support including a stage for supporting an object, and a column protruding downward from the stage and positioned in the accommodation space, and a tent membrane connecting an inlet of the accommodation space and the lower portion of the column to support the support to be spaced apart from the base.

In the above-described embodiment, if a linear rope has supported the support, in the present embodiment, a two-dimensional tent membrane may support the support. The two-dimensional tent membrane may be understood as a concept similar to a plurality of ropes tightly arranged, wherein the tent membrane may also be provided as a fabric that forms two dimension or other types of membranes or ropes, or a net made of a material in the form of a fiber.

The membrane or the net may be formed using at least one of graphene synthetic plastic containing a special alloy, graphene synthetic plastic, carbon fiber, carbon nanotube, and graphene.

### Advantageous Effects

According to the present invention, the seismic isolation structure using the rope foundation may actually float and separate an object from the ground, and even if a base moves, the object and a support may be substantially kept in a stationary state by inertia. If the ground is the bedrock and the object is a building, the building may be substantially made to float in the air, thereby effectively protecting the building even when an earthquake occurs.

In addition, since it is possible to support an object using a plurality of ropes or tent membranes, and it is possible to repeatedly cross and support the ropes according to the load of the object, it is possible to provide an optimal design with the reinforced tensile force of the rope even in a large load. In particular, if a rope made of an ultra-high tensile material is used, it is possible to design a structure to withstand the load of a high-rise building by forming a rope repeating structure with a relatively small amount or a small number of times.

The structure may withstand a large load of not only general buildings, but also skyscrapers with hundreds of stories including special equipment structures such as nuclear power plants and semiconductor factories, and may be naturally restored after being shaken by the shock of a great earthquake.

In addition, since maintenance, repair and replacement of the rope is easy, the rope does not corrode even after hundreds of years, so that the seismic isolation performance may not be deteriorated, and an effective and economical seismic isolation structure may be provided.

In addition, the seismic isolation structure of the present invention may be easily modularized and can be fabricated or manufactured in various sizes or shapes. Accordingly, the seismic isolation structure may be applied in series and parallel according to the size of the building or the required seismic isolation performance, thereby shortening a period of construction of a seismic isolation foundation and increasing economic efficiency.

In particular, when a rope, a membrane, or a net made of a graphene material is used, shock may be absorbed not only horizontally shaking vibration in all directions, but also vertical vibration.

Of course, in addition to earthquake isolation of buildings, various uses are possible. It is also possible to provide a seismic isolation system capable of protecting important facilities or computing equipment inside a building from earthquakes by making the system for a small indoor use even in the building.

### DESCRIPTION OF DRAWINGS

FIG. 1 is a diagram for describing a three-dimensional structure of a seismic isolation structure using a rope foundation according to an embodiment of the present invention.

FIG. 2 is a diagram for describing a front structure of the seismic isolation structure of FIG. 1.

FIG. 3 is a diagram for describing a structure of a seismic isolation structure using a rope foundation according to an embodiment of the present invention.

FIGS. 4 and 5 are diagrams for describing operations of the seismic isolation structure of FIG. 3.

FIG. 6 is a diagram for describing a relationship between elasticity and vertical vibration of a rope in the seismic isolation structure according to an embodiment of the present invention.

FIG. 7 is a diagram for describing a structure of a seismic isolation structure using a rope foundation according to an embodiment of the present invention.

FIG. 8 is a plan view of the seismic isolation structure of FIG. 7.

FIG. 9 is a diagram for describing materials of the rope in the seismic isolation structure according to an embodiment of the present invention.

FIG. 10 is a diagram for describing a structure of a seismic isolation structure using a rope foundation according to an embodiment of the present invention.

FIG. 11 is a diagram for describing rope length correction using a turnbuckle in FIG. 10.

FIG. 12 is a diagram for describing rope length correction in the seismic isolation structure using the rope foundation according to an embodiment of the present invention.

FIG. 13 is a diagram for describing a structure of connecting a base and a support in a seismic isolation structure using a rope foundation according to an embodiment of the present invention.

FIG. 14 is a diagram for describing a case of using sand or gravel in a seismic isolation structure using a rope foundation according to an embodiment of the present invention.

FIG. 15 is a diagram for describing a structure of connecting a base and a support in a seismic isolation structure using a rope foundation according to an embodiment of the present invention.

FIG. 16 is a diagram for describing a critical shock blocking device in the seismic isolation structure of FIG. 15.

FIG. 17 is a diagram for describing a process of installing the critical shock blocking device in the seismic isolation structure of FIG. 15.

FIG. 18 is a diagram for describing a critical shock blocking device in a seismic isolation structure according to an embodiment of the present invention.

FIGS. 19 to 21 are diagrams for describing examples using a seismic isolation structure according to an embodiment of the present invention.

FIGS. 22 and 23 are diagrams for describing a structure of connecting a base and a support in a seismic isolation structure using a rope foundation according to an embodiment of the present invention.

FIGS. 24 to 27 are diagrams for describing examples using a seismic isolation structure according to an embodiment of the present invention.

FIG. 28 is a diagram for describing a seismic isolation structure according to an embodiment of the present invention.

### MODES FOR THE INVENTION

Hereinafter, embodiments of the present invention will be described in detail with reference to the accompanying drawings, but the present invention is not limited or restricted to the embodiments. For reference, in the description, like reference numerals substantially refer to like elements, which may be described by citing contents disclosed in other drawings under such a rule and contents determined to be apparent to those skilled in the art or repeated may be omitted.

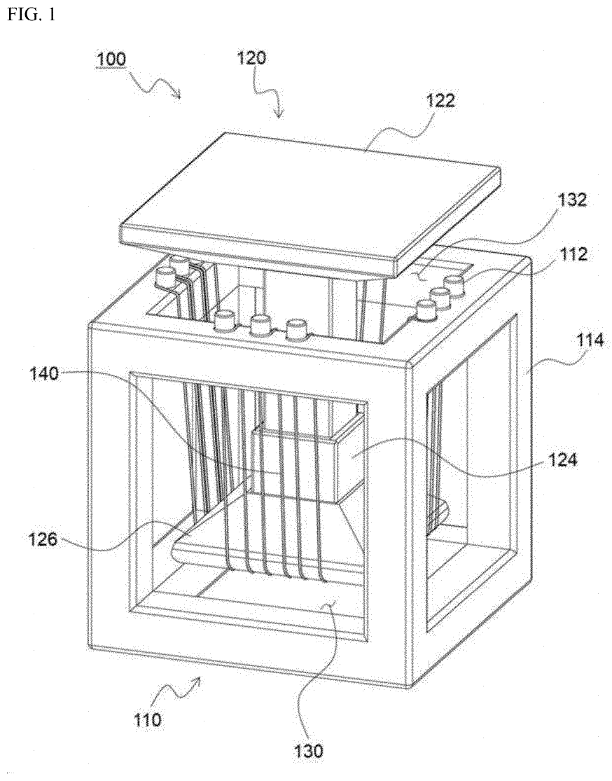

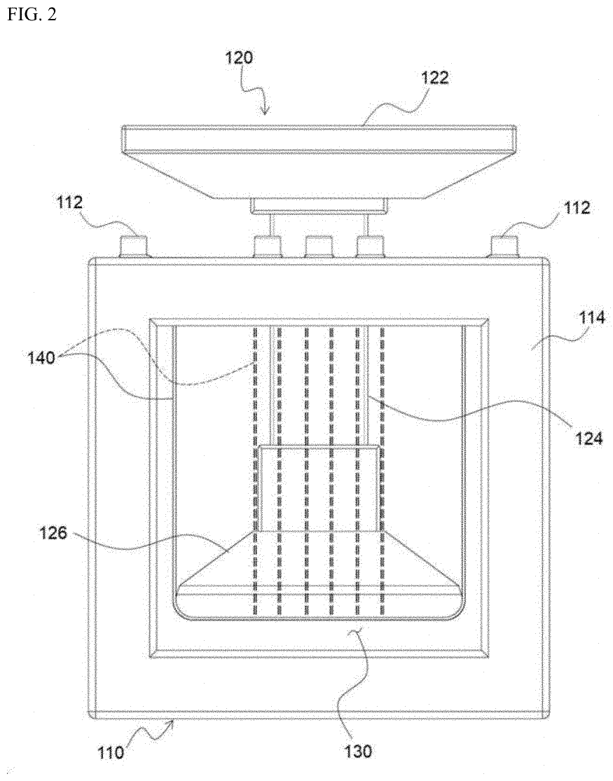

FIG. 1 is a diagram for describing a three-dimensional structure of a seismic isolation structure using a rope foundation according to an embodiment of the present invention and FIG. 2 is a diagram for describing a front structure of the seismic isolation structure of FIG. 1.

Referring to FIGS. 1 and 2, a seismic isolation structure according to the present embodiment may include a base 110, a support 120, and ropes 140, and may separate and support an object from the ground at the same time.

In a building, the load may be compressed through walls, foundations, etc. to be transmitted to the bedrock corresponding to the ground. Accordingly, the seismic isolation structure is provided below of the building and separately isolates the base 110 and the support 120, and at the same time, may prevent the shock of the earthquake and the like from the ground from being transmitted to the support 120 and the building thereon.

The base 110 may be positioned on the ground, and may include an accommodating space 130 with an opened upper portion and two or more rope supporters 112 spaced apart around an entrance 132 of the accommodating space 130.

The base 110 and the support 120 may be formed by using reinforced concrete, steel framed concrete, durable steel frame, special high-strength alloy, graphene synthetic plastic containing a special alloy, graphene synthetic plastic, carbon fiber, carbon nanotube, graphene, and the like.

The support 120 may include a stage 122 for supporting an object, a column 124 protruding downward from the stage 122 and positioned in the accommodation space 130, and a flange 126 formed below the column 124.

The stage 122 may support a building or a column, or other support structures, and may also include a separate fastening structure. The stage 122 may be provided in the form of a dumbbell as a whole by the stage 122, the column 124 and the flange 126, and the height may be adjusted to be located at the entrance 132 of the accommodation space 130 on the narrow column 124.

The flange 126 may have a relatively larger dimension than the column 124, and a lower surface of the flange 126 through which the rope 140 passes may form a gently curved surface.

In the accommodating space 130 in the base 110, the column 124 and the flange 126 of the support 120 are positioned, but may maintain a spaced state without colliding with the base 110.

A plurality of rope supporters 112 may be formed on the upper surface of the base 110 around the entrance 132 of the accommodating space 130. Three or more rope supporters 112 may be formed on each side of the entrance 132 of the accommodation space 130 in the shape of a mooring column, and the ropes 140 may form a plurality of rope lines on the side of the support 120 while repeatedly passing through the lower surface of the rope supporter 112 and the flange 126.

The plurality of ropes 140 or rope lines may effectively distribute the load applied to the support 120, and stably support the support 120 and the object through the tensile force. In the embodiment, it is possible to maintain stable support by positioning the lower surface of the flange 126 below the entrance 132 of the accommodation space 130.

The rope 140 may be formed of a material having excellent durability, such as a hanger rope, a steel wire, graphene synthetic plastic containing a special alloy, graphene synthetic plastic, carbon fiber, carbon nanotube, graphene, and the like.

In this specification, the term ‘ground’ may mean exposed from an exterior such as the bedrock, the ground, the building floor, and the like by vibration, shock, shaking, etc. The ‘object’ is an object that is protected from vibration, shock, shaking, and the like transmitted from the ground, and may be defined in various ways without being limited by size or position, such as buildings, bridges, cultural assets, expensive equipment, and works of art. In the embodiment, the ground may be assumed as the bedrock, and the object may be assumed as a building.

Accordingly, even if the vibration caused by the earthquake is transmitted to the bedrock and the base 110, the building and the support 120 may be supported through the rope 140, but as the rope 140 shakes, the vibration is not transmitted or may be significantly offset.

Referring to FIG. 2, the ropes 140 connecting the upper portion of the base 110 and the lower portion of the support 120 in a state without shaking are preferably all vertically parallel to each other. Here, ‘vertical’ is parallel to the direction of gravity, and if the applied force is not gravity, the ‘vertical’ direction may also be understood as a direction parallel to the direction in which the support is pulled or pushed with respect to the base.

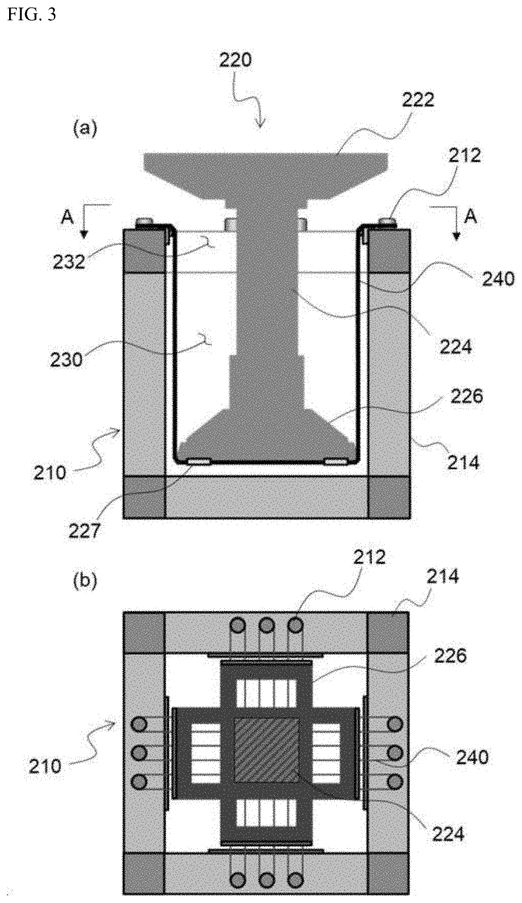

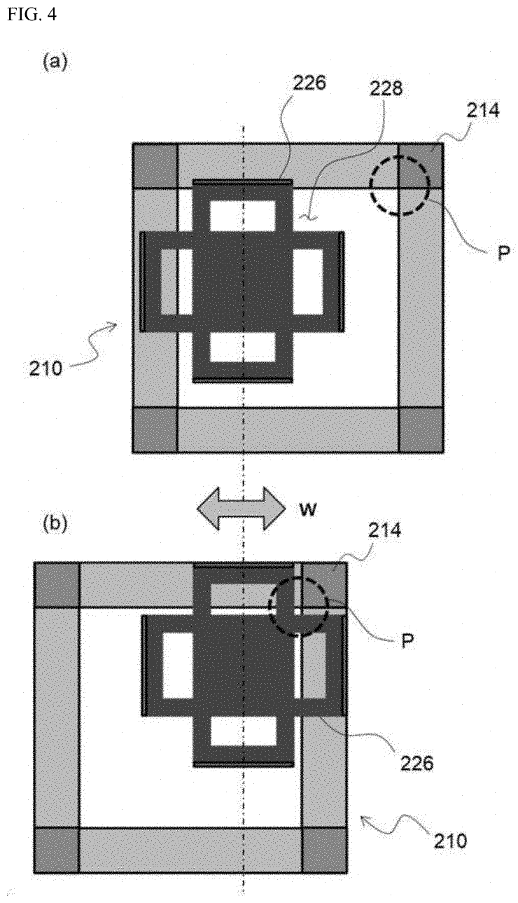

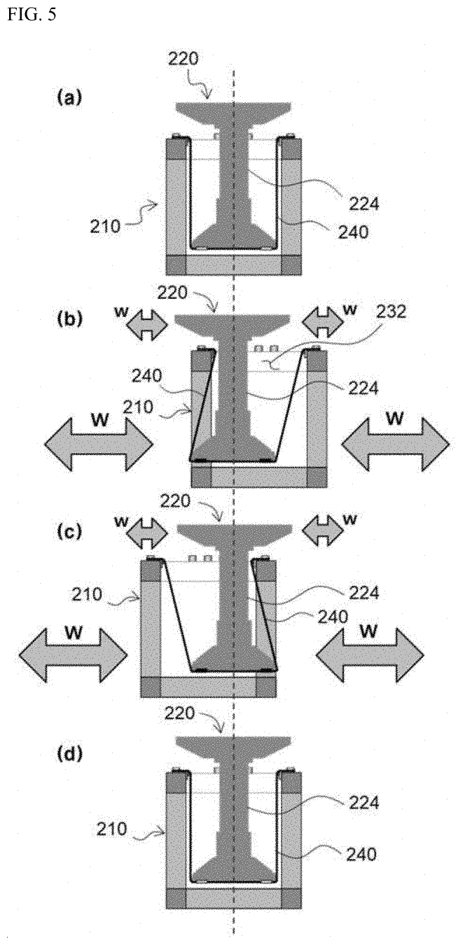

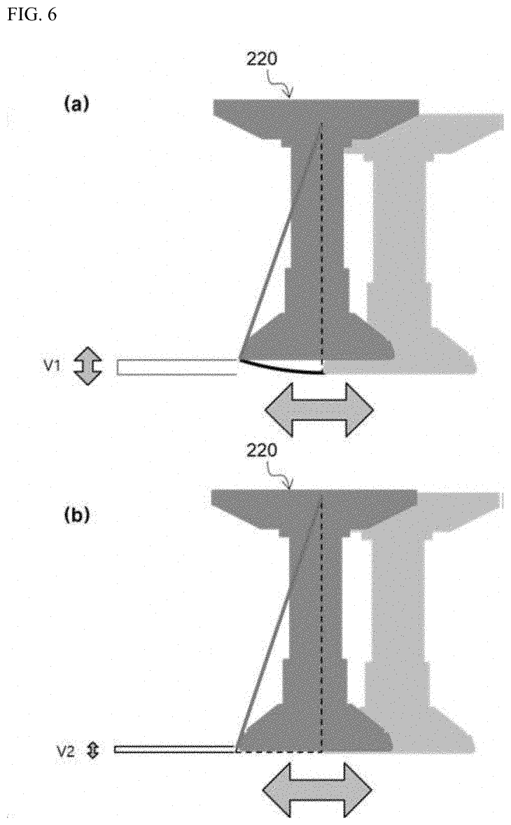

FIG. 3 is a diagram for describing a structure of a seismic isolation structure using a rope foundation according to an embodiment of the present invention, FIGS. 4 and 5 are diagrams for describing operations of the seismic isolation structure of FIG. 3, and FIG. 6 is a diagram for describing a relationship between elasticity and vertical vibration of a rope in the seismic isolation structure according to an embodiment of the present invention.

Referring to FIGS. 3 to 6, a seismic isolation structure according to the present embodiment may include a base 210, a support 220, and ropes 240.

The base 210 may be positioned on the ground such as the bedrock, may include an accommodating space 230 with an opened upper portion and two or more rope supporters 212 spaced apart around an entrance 232 of the accommodating space 230, and may be provided in a hexahedral skeleton structure in which front, rear, left, and right sides are opened.

The support 220 may include a stage 222, a column 224 positioned in the accommodation space 230, and a flange 226 formed on the lower portion of the column 224, and may be adjusted in height so that a relatively narrow column 224 is positioned at the entrance 232 of the accommodating space 230 in the stage 222, the column 224, and the flange 226.

The flange 226 may have a relatively larger dimension than the column 224 so that the ropes 240 are all provided vertically.

In the accommodating space 230 in the base 210, the column 224 and the flange 226 of the support 220 are positioned, but may maintain a spaced state without colliding with the base 210.

A plurality of rope supporters 212 are provided on the upper surface of the base 210 around the entrance 232 of the accommodating space 230, and the rope 240 passes through the lower surface of the rope supporter 212 and the flange 226 to form a plurality of rope lines on the side of the support 220. The rope is fixed (227) to the lower surface of the flange 226 so that relative slippage does not occur.

The plurality of ropes 240 are preferably vertically parallel with each other. To this end, the flange 226 and the boundary of the entrance 232 of the base 210 may be designed to be matched vertically, and rope guide grooves or protrusions are additionally formed on the entrance 232 of the base 210 or the outside of the flange 226 to adjust the dimension so that the ropes are vertical or prevent the ropes from moving unintentionally.

Two arbitrarily selected from the ropes 240 formed above may be vertically formed with the same length as each other to form two opposite sides forming a rectangle.

As illustrated in FIGS. 3 and 4, in order to prevent the flange 226 positioned in the accommodation space 230 from colliding with the base 210, the front, rear, left, and right sides of the base 210 may be opened. The support 220 forms a concave corner 228 of the flange 226 to prevent collision with a vertical column 214 of the base 210 so that the vertical column 214 of the base 210 and the flange 226 do not collide with each other as much as possible even if the flange 226 moves to a colliding position P.

When horizontal vibration W such as an earthquake in FIG. 4 is transmitted to the base 210, it can be seen that the base 210 moves relatively much by the support 220, and the support 220 is affected by inert and the like to less deviate from an initial position (see a center line).

Referring to FIG. 5, in the case of no-shaking (FIG. 5A), the boundary by the rope 240 may correspond to a rectangle. When an earthquake occurs, the base 210 may greatly vibrate W laterally along with the bedrock (FIGS. 5B and 5C), but the boundary by the rope 240 is only transformed from the rectangle to a parallelogram, and the support 220 may hold its initial position or shake with a relatively small vibration w.

As illustrated in FIG. 6, even if the rope and the support significantly offset the largely lateral vibration of the base, vibration may occur vertically. Of course, the vibration transmitted according to the inertia of the support and the building may also vary.

In addition, when the support 220 is shaken horizontally, the vertical and vertical movement may also be affected according to the elasticity of the rope. For example, as the elasticity of the rope is less, the vertical vibration may be greatly generated, and as the elasticity is increased, the vertical vibration may be offset. Therefore, in order to reduce the vertical vibration of the support, it is also possible to use a relatively high elastic rope or to add a spring to the rope.

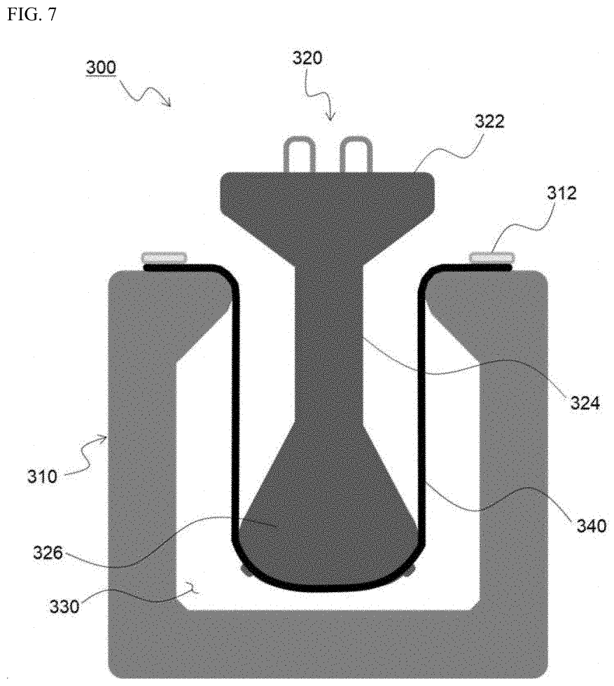

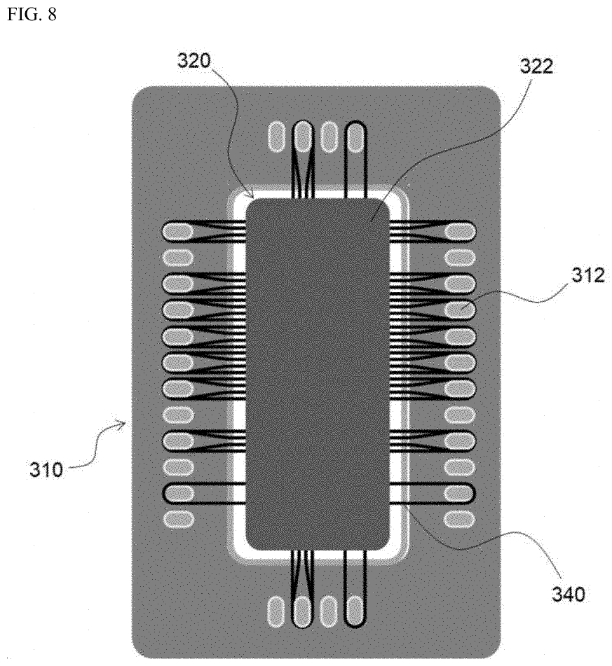

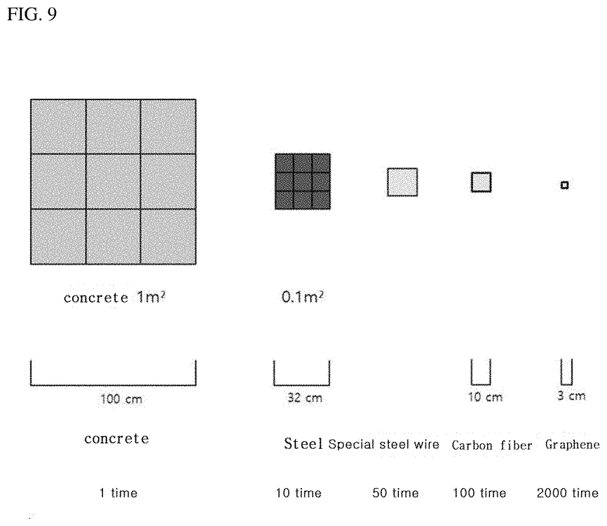

FIG. 7 is a diagram for describing a structure of a seismic isolation structure using a rope foundation according to an embodiment of the present invention, FIG. 8 is a plan view of the seismic isolation structure of FIG. 7, and FIG. 9 is a diagram for describing materials of the rope in the seismic isolation structure according to an embodiment of the present invention.

Referring to FIGS. 7 to 9, a seismic isolation structure according to the present embodiment may include a base 310, a support 320, and ropes 340. The base 310 forms an accommodating space 330 with an opened upper portion, and may provide rope supporters 312 on both sides of an entrance of the accommodating space 330.

The support 320 may include a stage 322, a column 324 positioned in the accommodating space 330, and a flange 326 formed on the lower portion of the column 324, and the plane thereof may be formed in a rectangular shape rather than a square shape.

A plurality of rope supporters 312 are provided on the upper surface of the base 310 around the entrance of the accommodating space 330, and since the rope supporter is formed in a rectangular shape, a relatively large number of rope supporters 312 may be formed on the long side. The rope 340 may form a plurality of rope lines on the side of the support 320 while passing through the rope supporter 312 and the lower surface of the flange 326, but the rope 34 may pass through all of the rope supporters 312, and in some cases, the ropes may be concentrated to be locked to some rope supporters 312.

As listed in FIG. 9, a graphene wire having a thickness of about 3 cm may have a strength equivalent to a steel structure of about 0.1 m² or a concrete structure of about 1 m². Therefore, if the ropes or other structures are formed with graphene, miniaturization is also possible.

In addition, when using a rope made of a steel wire, the tensile strength may be formed about 10 times larger than steel of the same thickness. A steel wire with a diameter of about 16 mm may have a cross-sectional area of about 2 cm², and since the steel wire may support about 30 tons per 1 cm², a steel wire rope with a cross-sectional area of about 2 cm² may support about 60 tons.

If the steel wire ropes are arranged at intervals of about 70 mm to form 56 rope lines, the steel wire ropes may support a total of about 3,360 tons, and if four such seismic isolation structures are disposed at 4 corners of the building, about 13,440 tons of the load of the building may be supported. For reference, the total weight of the Eiffel Tower in Paris is about 7,500 tons.

Furthermore, considering that the rope using graphene has a tensile strength that is at least 10 times higher than that of a steel wire with the same thickness, a seismic isolation structure using a graphene rope can be applied to buildings that withstand a load of 10 times or more.

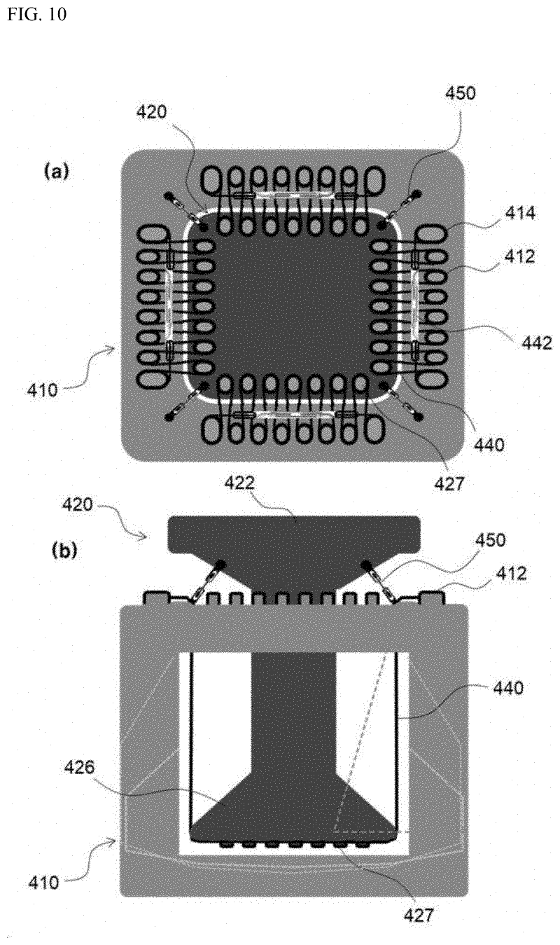

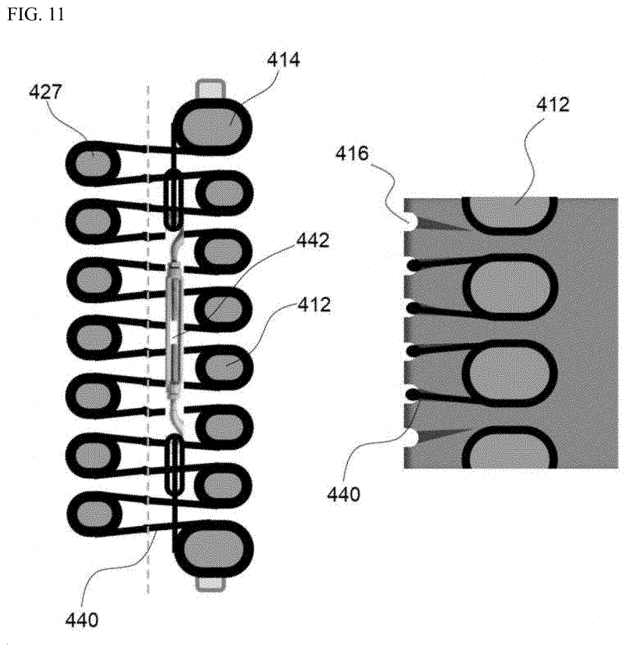

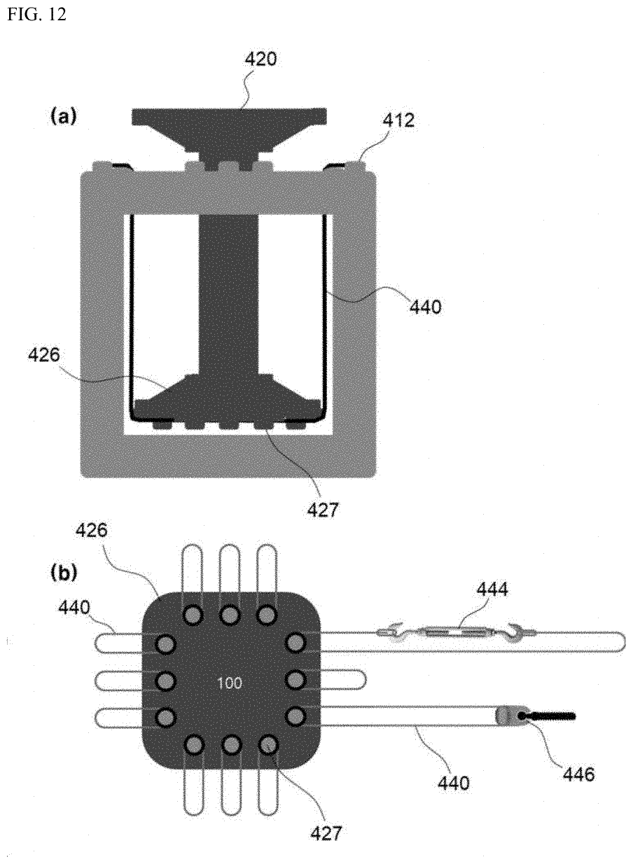

FIG. 10 is a diagram for describing a structure of a seismic isolation structure using a rope foundation according to an embodiment of the present invention, FIG. 11 is a diagram for describing rope length correction using a turnbuckle in FIG. 10, and FIG. 12 is a diagram for describing rope length correction in the seismic isolation structure using the rope foundation according to an embodiment of the present invention.

Referring to FIGS. 10 and 11, a seismic isolation structure according to the present embodiment may include a base 410, a support 420, ropes 440, and a critical shock blocking device 450. The base 410 forms an accommodation space with an opened upper portion, and a plurality of rope supporters 412 around an entrance of the accommodation space 430 and outer rope hangers 414 on both sides thereof may be provided.

In addition, a flange 426 of the support 420 may be provided with a lower rope hanger 427 corresponding to the rope supporter 412. Accordingly, the rope 440 may form a plurality of rope lines connecting the top and bottom while alternately passing through the rope supporter 412 on the base 410 and the lower rope hanger 427 of the flange 426.

While the ropes in the previous embodiment are connected to the rope supporter on the opposite side via the lower surface of the flange, in the embodiment, the ropes 440 may be formed while reciprocating up and down from one side of the support 420. Therefore, in the embodiment, the four ropes may be separately formed on the front, rear, left, and right sides, respectively.

The respective ropes 440 may be entangled with each other while reciprocating between the rope supporter 412 and the lower rope hanger 427, and both ends of the rope may be connected to a turnbuckle 442 via the outer rope hanger 414. In this case, it is possible to finely adjust the rope length using the turnbuckle 442. A rope fixing device capable of fixing the corrected rope by the turnbuckle 442 may be further added to the outside of the outer rope hanger 414.

As illustrated in FIG. 10B, the lower portion of the stage 422 of the support 420 and the upper portion of the base 410 may be additionally connected to each other by the critical shock blocking device 450. The critical shock blocking device 450 may be set to withstand heavily elastic earthquake resistance without over-responding to wind pressure such as typhoons or gusts or to some extent weak earthquakes. In addition, the shock may be designed to be broken when a critical shock greater than or equal to a certain level is applied.

Even in the upper portion of the base 410, guide grooves 416 may be further formed on the inner wall of the entrance of the accommodation space for positioning and vertically aligning the ropes 440.

Referring to FIG. 12, various turnbuckles 444 and 446 may be provided even while connecting the ropes. For example, the rope length may be finely adjusted using the turnbuckle 444 in the middle of the rope 440, and the rope 440 can be controlled by passing through the turnbuckle 446 fixed to a specific structure such as a base. Of course, a combined structure thereof is also possible.

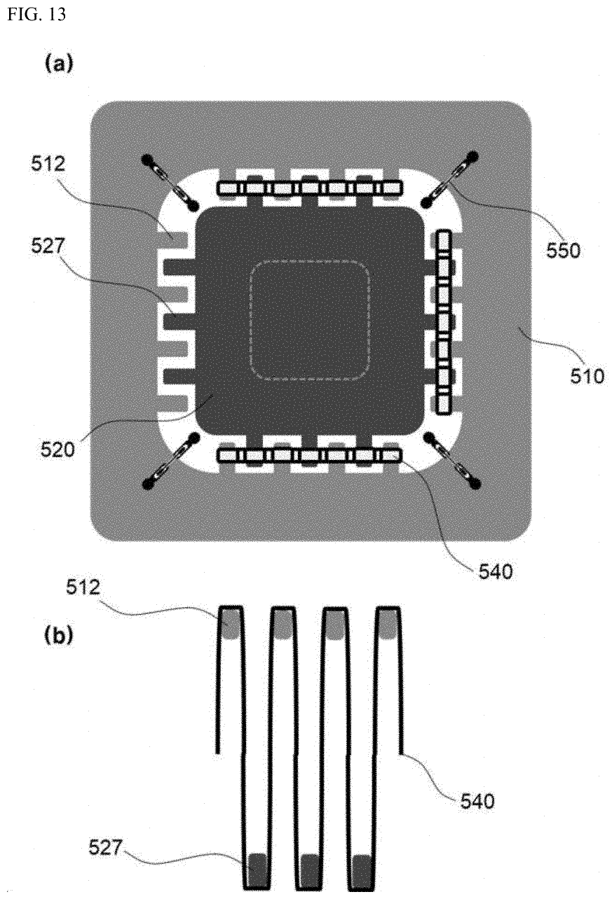

FIG. 13 is a diagram for describing a structure of connecting a base and a support in a seismic isolation structure using a rope foundation according to an embodiment of the present invention.

Referring to FIG. 13, a seismic isolation structure according to the present embodiment may include a base 510, a support 520, ropes 540, and a critical shock blocking device 550. In the previous embodiment, the rope supporter and the lower rope hanger were formed on the upper surface of the base and the lower surface of the flange, respectively, but in the present embodiment, a rope supporter 512 of the base 510 and a lower rope hanger 527 of the support 520 may be formed to protrude toward the side.

The rope 540 may be formed in a flat belt shape, and as illustrated in FIG. 13B, the rope 540 may form a plurality of rope lines while alternately passing through the upper rope supporter 512 and the lower rope hanger 527.

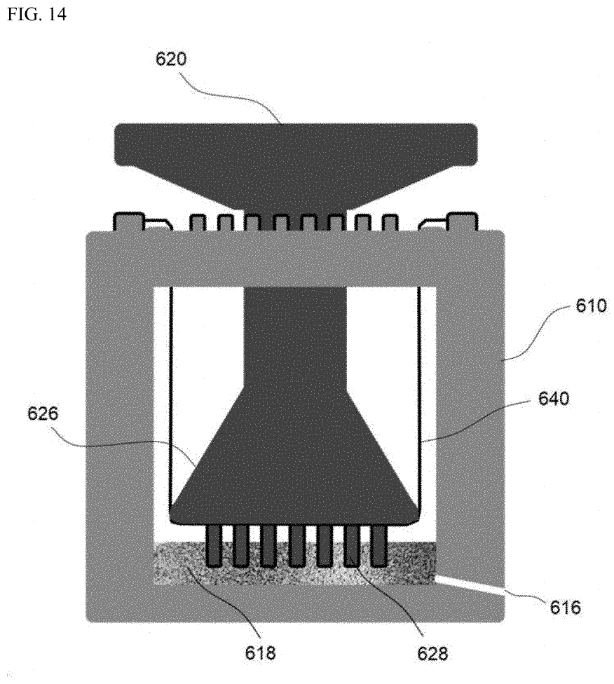

FIG. 14 is a diagram for describing a case of using sand or gravel in a seismic isolation structure using a rope foundation according to an embodiment of the present invention.

Referring to FIG. 14, a seismic isolation structure according to the present embodiment may include a base 610, a support 620, and a rope 640. In addition, sand or gravel 618 may be provided in an accommodating space inside the base 610, and a resistor 628 may be formed to protrude from the lower surface of a flange 626 of the support 620. The resistor 628 may be partially buried in the sand or gravel 618 to limit the movement of the support 620.

A drain 616 may be formed downward of the base 610 so that rainwater or groundwater introduced therein may be discharged to the outside.

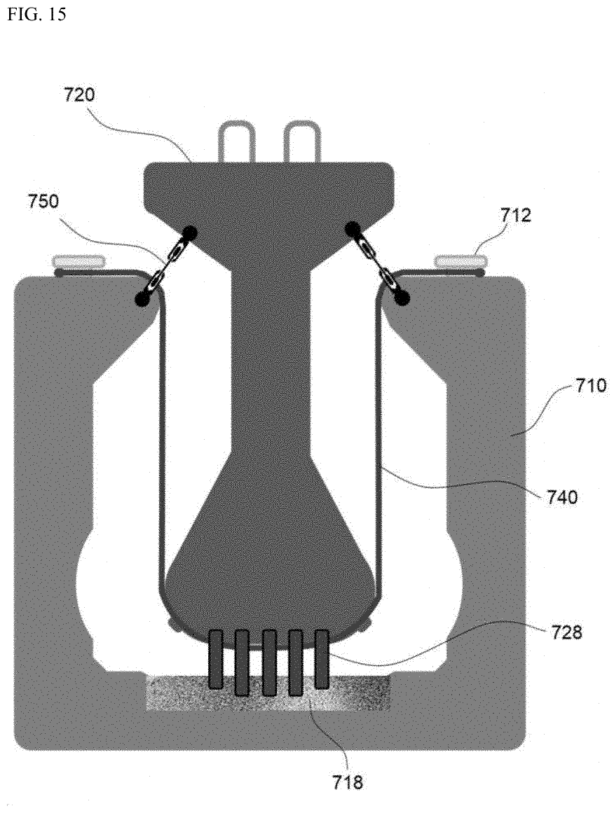

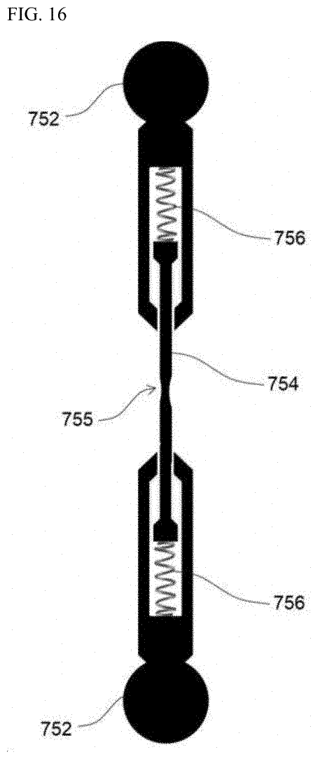

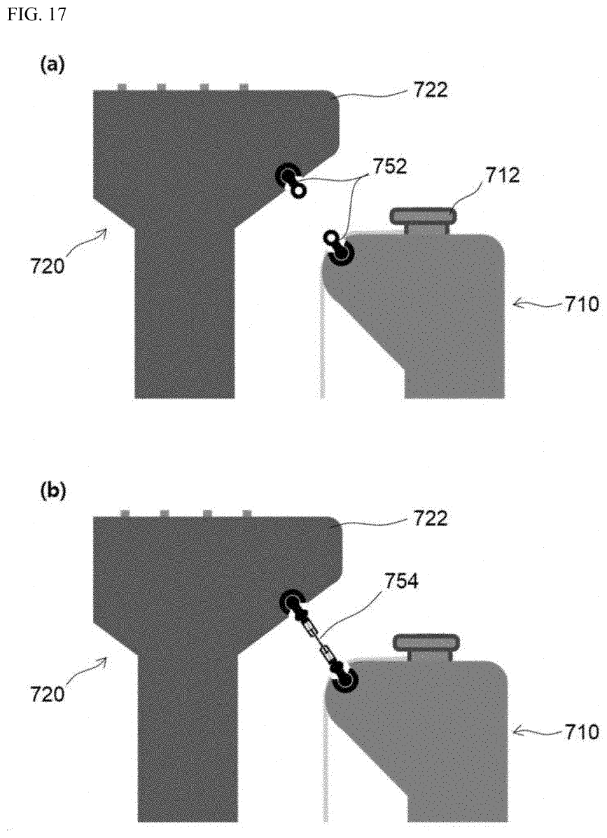

FIG. 15 is a diagram for describing a structure of connecting a base and a support in a seismic isolation structure using a rope foundation according to an embodiment of the present invention, FIG. 16 is a diagram for describing a critical shock blocking device in the seismic isolation structure of FIG. 15, and FIG. 17 is a diagram for describing a process of installing the critical shock blocking device in the seismic isolation structure of FIG. 15.

Referring to FIGS. 15 to 17, a seismic isolation structure according to the present embodiment may include a base 710, a support 720, a rope 740, and a critical shock blocking device 750. The rope 740 may be constrained to the rope supporter 712 of the upper portion of the base 710 or pass through the lower portion of the support 720 via the rope supporter 712, and a resistor 728 protrudes from the lower surface of the support 720 to restrict the movement of the support 720 by the sand or gravel 718.

The critical shock blocking device 750 may provide resistance to wind pressure, a weak earthquake, or the like while limiting the movement of the support 720 while stretching within a predetermined range. To this end, the critical shock blocking device 750 may include anchors 752 at both ends, a connecter 754 connecting the anchors 752, and a spring 756 mounted between the anchor 752 and the connector 754.

Accordingly, when a gust of wind, wind pressure, a weak earthquake, or the like is applied, the critical shock blocking device 750 may limit the movement of the support 720. However, when a force greater than or equal to a critical shock such as a high-strength earthquake is applied, a central portion 755 of the connector 754 is flexibly stretched or damaged, so that the support 720 is seismically isolated from the base 710.

The anchor 752 may be rotatably fixed to the lower surface of the stage 722 of the support 720 and the upper portion of the base 710, and may use a structure such as a ball joint.

In addition, the anchor 752 may be connected to the connector 754. When the connecter 754 is broken, it is also possible to replace the connecter 754.

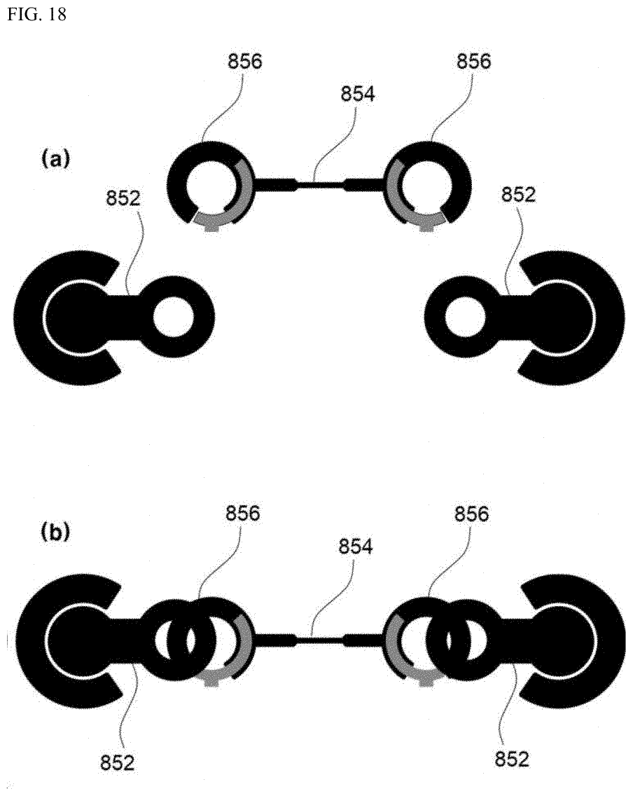

FIG. 18 is a diagram for describing a critical shock blocking device in a seismic isolation structure according to an embodiment of the present invention.

Referring to FIG. 18, a critical shock blocking device 850 of another embodiment may include anchors 852 at both ends and a connecter 854 for connecting the anchors 852, and biners 856 are formed at both ends of the connecter 854 to be easily connected to the anchors 852.

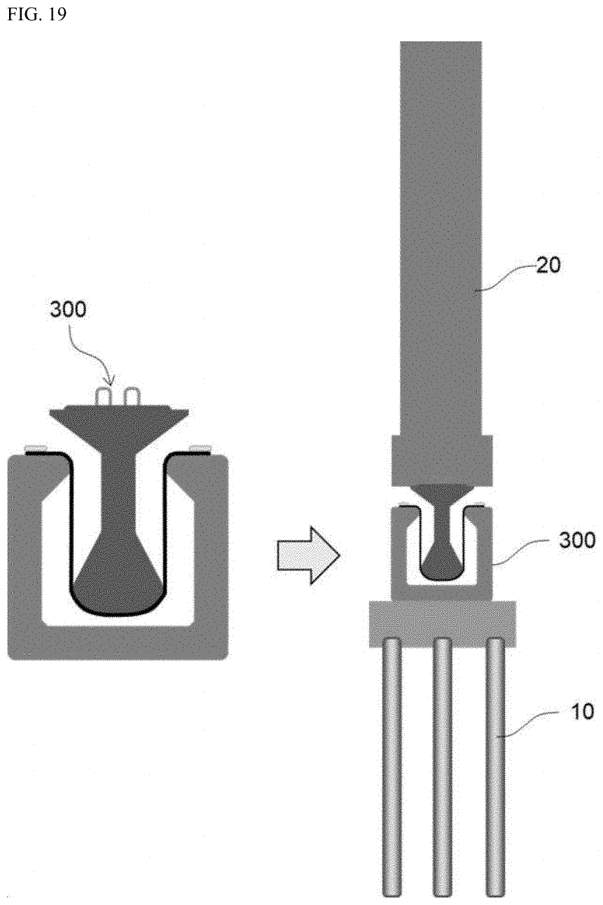

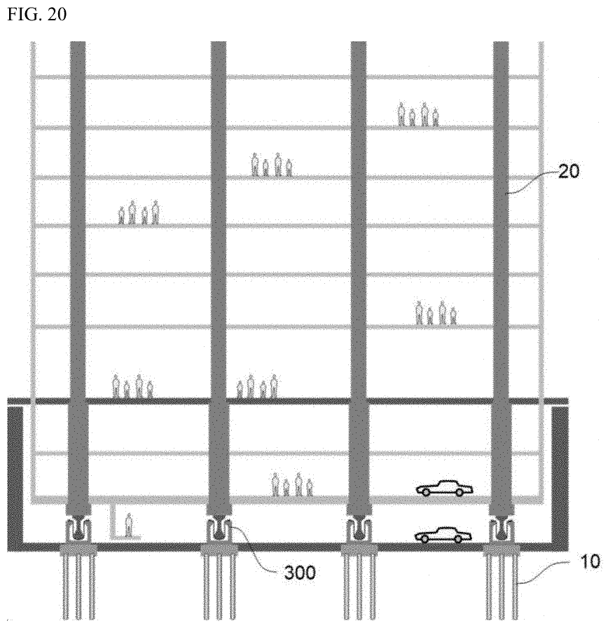

FIGS. 19 to 21 are diagrams for describing examples using a seismic isolation structure according to an embodiment of the present invention.

Referring to FIGS. 19 to 21, a seismic isolation structure 300 according to the present embodiment may be positioned between a pile 10 supported on the bedrock and a column 20 of a building. In addition, a building may be provided using the column 20. By using the pile 10 or the like, the seismic isolation structure 300 may be positioned at the same height regardless of the shape of the bedrock.

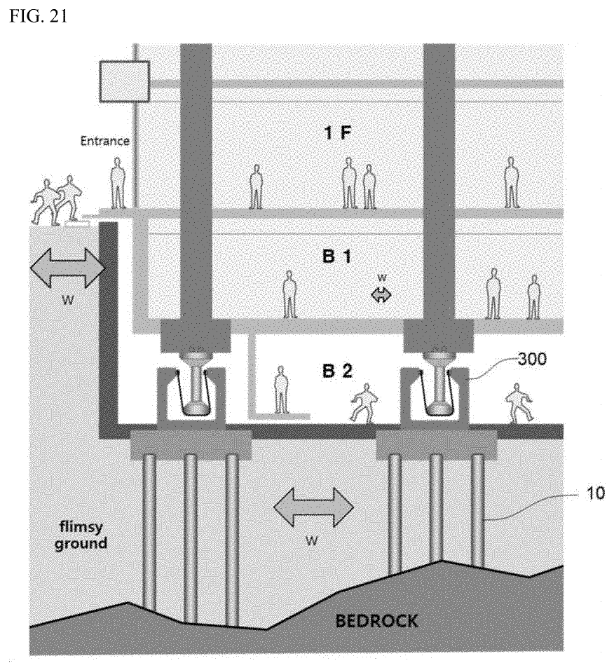

In addition, as illustrated in the drawings, the bedrock and the building are separated by the seismic isolation structure 300. Accordingly, even when shaking W by an earthquake occurs as illustrated in FIG. 21, only the bedrock and the ground based on the bedrock may be shaken, and the rope is tilted with respect to the base to hardly transmit the shaking.

It can be seen that the part of the building supported by the support may be kept in a very stable state without being impacted, while the ground connected to the bedrock shakes.

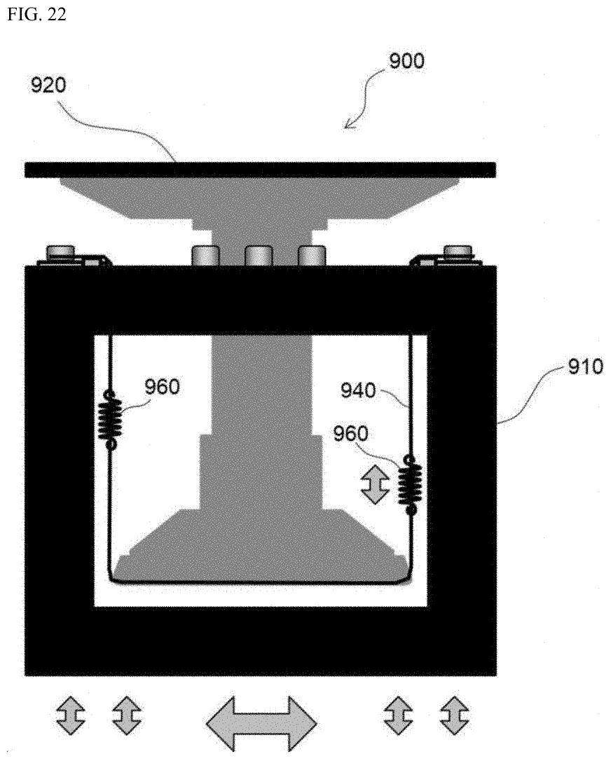

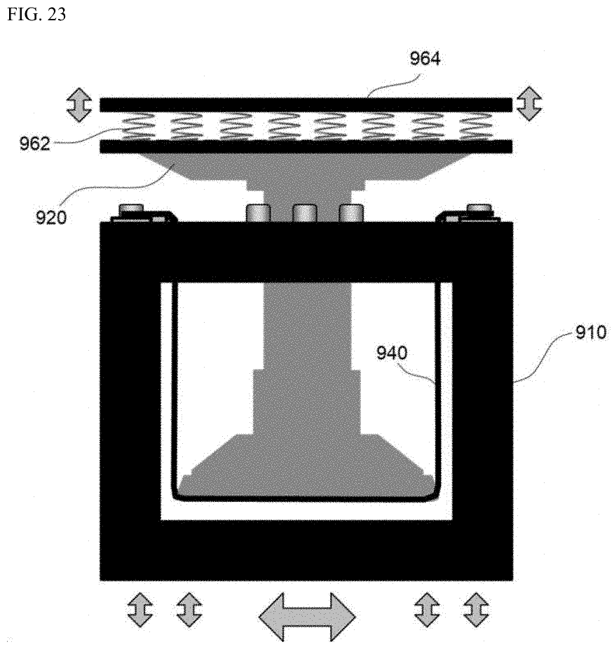

FIGS. 22 and 23 are diagrams for describing a structure of connecting a base and a support in a seismic isolation structure using a rope foundation according to an embodiment of the present invention.

Referring to FIG. 22, a seismic isolation structure according to the present embodiment may include a base 910, a support 920, and a rope 940. In addition, a spring 960 may be interposed in the center of the rope 940. It is possible to reduce the amount of converting the horizontal motion of the ground into the vertical motion of the support 920 by the spring 960. A process similar thereto may refer to FIG. 6B.

Referring to FIG. 23, a spring structure may also be provided on an upper portion of the support 920. A spring 962 and a spring plate 964 may be further provided on the upper surface of a stage of the support 920, and may provide a buffering effect against vertical vibration. In addition to this, a spring and a spring plate may be provided on the lower surface of the base.

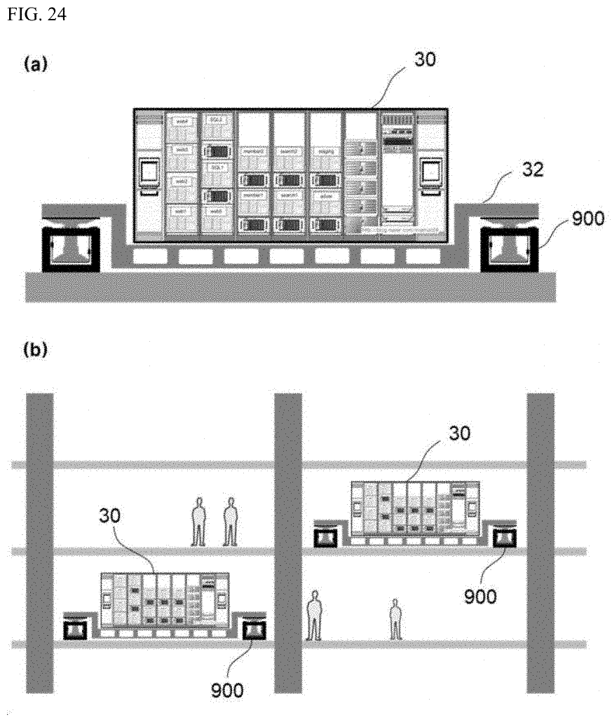

FIGS. 24 to 27 are diagrams for describing examples using a seismic isolation structure according to an embodiment of the present invention.

Referring to FIG. 24, a seismic isolation structure 900 according to the present embodiment may be applied to computation devices other than buildings and other devices vulnerable to shock. As illustrated in FIG. 24, a bottom plate 32 is provided to protect the computing equipment 30 such as a server, and a small seismic isolation structure 900 formed at the boundary of the bottom plate 32 may also be applied.

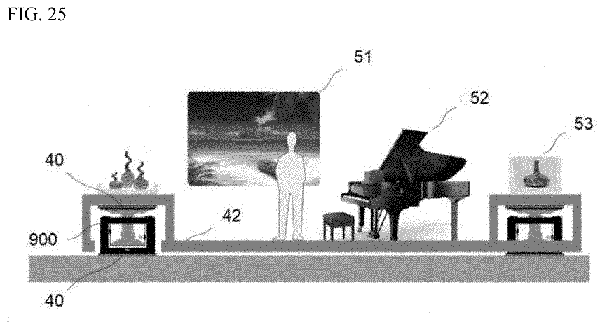

Referring to FIG. 25, the object can be applied even in general households. For example, an expensive art object 51, musical instrument 52, antique 53, etc. may also be the object, and vibration proof mats and the like may be added above and below the seismic isolation structure 900.

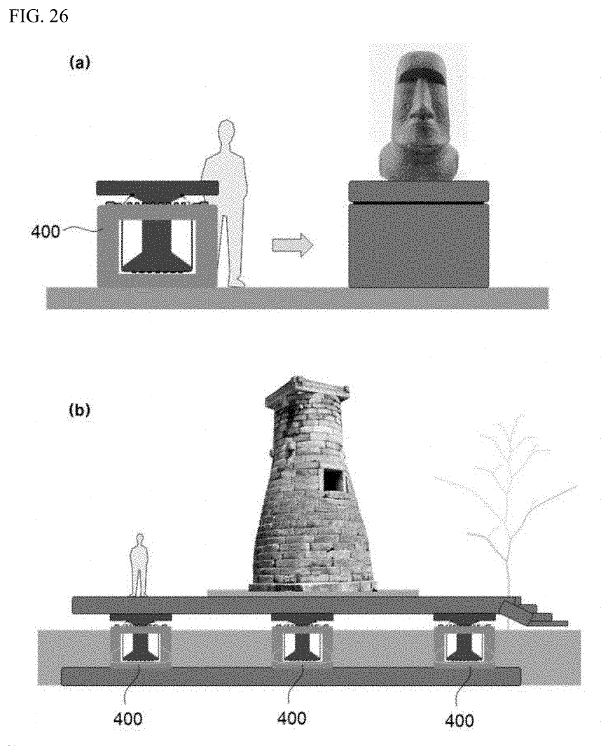

Referring to FIG. 26, a seismic isolation structure 400 according to the present embodiment may be applied to the protection of cultural assets. The seismic isolation structure 400 may also be applied to the lower part of a display stand for protecting the relics or exhibits of the museum, and may also be used for supporting the lower part of the relics or cultural assets.

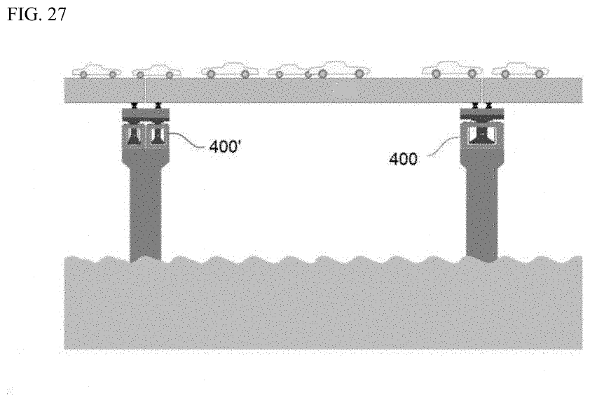

Referring to FIG. 27, the seismic isolation structure 400 may be applied to a bridge, and the seismic isolation structure 400 may be installed on the upper part of a pier and support a girder. In some cases, the seismic isolation structure 400 can be installed in the lower part of the pier.

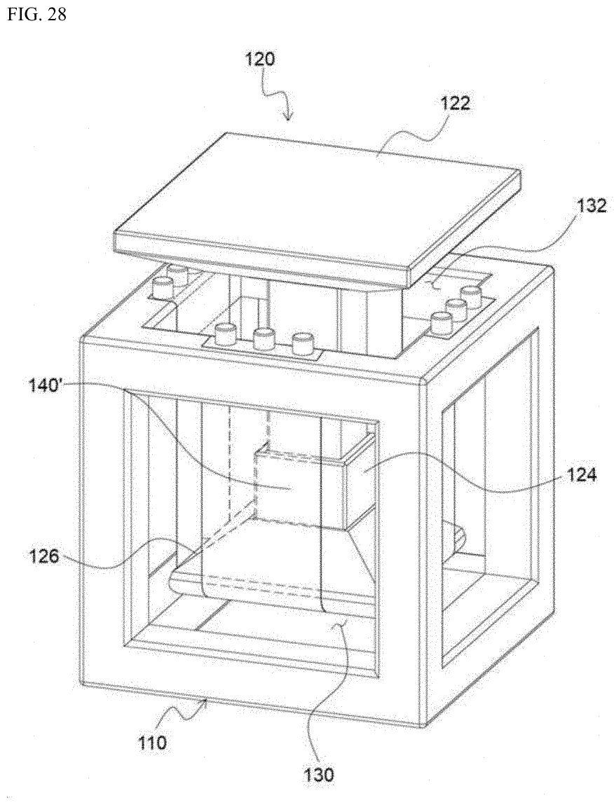

FIG. 28 is a diagram for describing a seismic isolation structure according to an embodiment of the present invention.

Referring to FIG. 28, the seismic isolation structure according to this embodiment includes a base 110, a support 120, and a tent membrane 140′, and the support 120 includes a stage 122, a column 124, and a flange 126.

The support 120 may maintain a state spaced apart from the base 110 in an accommodation space 130 by the tent membrane 140′, and may be adjusted in height so that the column 124 is positioned at an entrance 132 of the accommodation space 130.

The tent membrane 140′ may be provided in the form of a membrane or a net, and may be manufactured in various shapes as needed. In addition, the tent membrane 140′ may be formed using graphene synthetic plastic containing a special alloy, graphene synthetic plastic, carbon fiber, carbon nanotube, graphene, etc.

As described above, the present invention has been described with reference to the embodiments of the present invention. However, it will be appreciated by those skilled in the art that various modifications and changes of the present invention can be made without departing from the spirit and the scope of the present invention which are defined in the appended patent claims.

1. A seismic isolation structure for separating an object from a ground comprising:
a base positioned on the ground and provided with an accommodating space with an opened upper portion and two or more rope supporters spaced apart around an entrance of the accommodating space;
a support including a stage for supporting an object, and a column protruding downward from the stage and positioned in the accommodation space; and
ropes connecting the rope supporter and the lower part of the column to support the support to be spaced apart from the base.

2. The seismic isolation structure of claim 1, wherein all of the ropes connecting the upper portion of the base and the lower portion of the support are vertically parallel with each other in a no-shaking state.

3. The seismic isolation structure of claim 2, wherein two of the ropes randomly selected form two opposite sides of a rectangle.

4. The seismic isolation structure of claim 1, wherein the support includes a flange provided at the lower portion of the column and formed with a relatively wider dimension than the column.

5. The seismic isolation structure of claim 4, wherein the height of the column of the support is adjusted to be positioned at the entrance of the accommodation space to limit the collision between the support and the base when the base is shaken.

6. The seismic isolation structure of claim 1, wherein the support or the base is formed using at least one of reinforced concrete, steel frame concrete, steel frame with increased durability, a special high-strength alloy, graphene synthetic plastic containing a special alloy, graphene synthetic plastic, carbon fiber, carbon nanotube, and grapheme.

7. The seismic isolation structure of claim 1, wherein the rope is formed using at least one of a hanger rope, a steel wire, graphene synthetic plastic containing a special alloy, graphene synthetic plastic, carbon fiber, carbon nanotube, and graphene.

8. The seismic isolation structure of claim 1, wherein the seismic isolation structure is formed in a rectangular or circular shape in a plane.

9. The seismic isolation structure of claim 1, wherein the base has rope guide grooves or protrusions formed around the entrance of the accommodation space.

10. The seismic isolation structure of claim 1, wherein the front, rear, left, and right sides of the base are opened.

11. The seismic isolation structure of claim 10, wherein the support includes a flange provided on the lower portion of the column and formed with a relatively wider dimension than the column, and a corner of the flange adjacent to a vertical column of the base is partially concavely formed to remove interference with the vertical column of the base.

12. The seismic isolation structure of claim 1, wherein a spring is interposed in the center of the rope connecting the base and the support.

13. The seismic isolation structure of claim 1, further comprising:
a spring plate provided on the upper surface of the support or the lower surface of the base.

14. The seismic isolation structure of claim 1, further comprising:
at least one critical shock blocking device connecting spaced spaces between the support and the base, wherein the critical shock blocking device blocks the support and the base from being separated at a predetermined interval or more.

15. The seismic isolation structure of claim 14, wherein the critical shock blocking device includes anchors at both ends and a connecter connecting the anchors, and the connector is designed to be stretched or broken when a predetermined critical shock is exceeded.

16. The seismic isolation structure of claim 15, wherein the anchor and the connecter are connected to each other by a biner.

17. The seismic isolation structure of claim 1, wherein sand or gravel is provided below the accommodation space, and a resistor buried in the sand or gravel is formed to protrude from the lower portion of the support, and the sand or gravel restricts the movement of the support.

18. The seismic isolation structure of claim 1, wherein a plurality of independent ropes independently connects the rope supporter and the lower portion of the column.

19. The seismic isolation structure of claim 1, wherein the ropes are connected to each other to be interconnected while passing through the plurality of rope supporters.

20. The seismic isolation structure of claim 19, wherein outer rope hangers are provided on both sides of the rope supporter, the rope passes through to connect the outer rope hangers, and a turnbuckle for correcting the length of the rope is interposed between the outer rope hangers.

21. A seismic isolation structure for separating an object from the ground comprising:
a base positioned on the ground and providing an accommodation space with an opened upper portion;
a support including a stage for supporting an object, and a column protruding downward from the stage and positioned in the accommodation space; and
a tent membrane connecting an entrance of the accommodation space and the lower portion of the column to support the support to be spaced apart from the base.

22. The seismic isolation structure of claim 21, wherein the tent membrane is provided as a membrane or a net.

23. The seismic isolation structure of claim 22, wherein the membrane or the net is formed using at least one of graphene synthetic plastic containing a special alloy, graphene synthetic plastic, carbon fiber, carbon nanotube, and graphene.
